(19) United States
(12) Patent Application Publication
(10) Pub. No.: US 2009/0126810 A1
(43) Pub. Date: May 21, 2009

(54) Water Controller

(75) Inventor: Alan Currie, Auckland (NZ)

Correspondence Address: ARNOLD & KNOBLOCH, L.L.P., 2401 FOUNTAIN VIEW DRIVE, SUITE 630, HOUSTON, TX, 77057, US

(73) Assignee: JUBILEE BATHROOMS LIMITED, AUCKLAND (NL)

(21) Appl. No.: 11/993,808

(22) PCT Filed: Jun. 23, 2006
(86) PCT No.: PCT/NZ06/00161

§ 371 Date: Mar. 12, 2008

(30) Foreign Application Priority Data
Jun. 24, 2005 (NZ) 540977
Feb. 21, 2006 (NZ) 545456

(51) Int. Cl. F16K 31/02

(52) U.S. Cl. 137/624.12

(57) ABSTRACT

A system for controlling a flow of water comprising a solenoid controllable valve (106) adapted for connection in series with a water line (102) having a user operable control flow means (110) for conveying heated water, wherein the valve (106) is adapted to be operated by a solenoid such that when the solenoid is de-energised the valve is in a normally open state, and when the solenoid is energised the valve is in a closed state, a flow detector (103, 108) adapted to sense water flow in the water line, and a controller (100) adapted for communication with the flow detector (103, 108) and solenoid, wherein the controller is adapted to monitor water flow using the flow detector (103, 108) and is adapted to operate the solenoid controllable valve (106), wherein in response to detection of water flow the controller (100) is programmed to determine a no flow condition whereby the controller communicates with the solenoid controllable valve (106) to operate the solenoid controllable valve (106) from a normally open position to a closed position for part of a no flow period by energising the solenoid.

### FIELD OF THE INVENTION

The present invention relates to a water control system, and particularly though not solely, to a water control system for controlling water and/or energy use in relation to a shower mixer, califont, bath or the like.

### BACKGROUND

It is known in the art to provide a mechanical valve for both hot and cold water in a shower mixer, bath or califont to achieve a desired temperature of the water provided at the shower head. In order to conserve water consumption and therefore the amount of energy required to heat the water various efforts have been made to reduce the flow through the shower head. As well it is known to provide electronic temperature control systems which control the temperature of the delivered water.

For example international Patent Publication No. WO 93/14451 describes a electronically controlled shower controller governing the time period and consumption of hot and cold shower water in domestic and commercial applications. Upon turning on shower taps a flow switch or sensor (1) activates and signals a central processing unit (2) which activates 3 dual function timers which time and regulate the amount of water by operating 3 solenoids. At the end of a fully adjustable time period the hot water main solenoid snaps shut. This leaves the secondary hot water solenoid open along with the cold water solenoid to give a period of warm water. At the end of this period the hot water secondary solenoid snaps shut giving a period of cold water only. At the end of the cold water period the cold water solenoid snaps shut ending the shower. After a given time period the shower timer resets ready for the next shower cycle.

In a further example Japanese Patent Publication No. 5015466 describes a shower device with an optimum preparation function by allowing the device to start to discharge water a predetermined time after an indoor remote switch has been operated and to inform that the inside of a hot-water supply line has reached an appropriate temperature. Remote switch 81a, 81b, 81c, or 81d is pushed, then after a predetermined time, a hot water supply monitor 84 lights up, electric switch valves 5a through 5d are opened, hot water starts to be supplied, and a monitor lamp 9a begins flashing. When the temperature detection of a temperature sensor 4 indicates that an appropriate temperature has been reached, the electric switch valves 5a through 5d are closed and the monitor lamp 9a lights up to inform that it is good time to take shower. The user will not be showered upon by discharged water because he or she is outside the bathroom B. This arrangement prevents the inconvenience of water that is already cold when the user actually takes a shower, despite the fact that an appropriate temperature in the water supply has been reached.

In still a further example Japanese Patent Publication No. 1246613 describes a fluctuating shower of hot water comfortable for a human body by automatically varying the temperature of supply hot water and controlling the temperature width and the time width. Hot water supply piping 15 and a cold water supply piping 16 from a hot water supply machine 14 are connected to a mixing unit 17, and hot water whose temperature is controlled by the unit 17 is supplied from a faucet 18 or a shower 19. A valve part 20 and a control part 21 are incorporated in this mixing unit 17 and they are connected to a setter 22, a temperature sensor 23, and the hot water supply machine 14 by signals, and they are constituted into a shower unit 23 as one body. This setter 22 is provided with a fluctuation switch for the start of fluctuation, a waveform switch which switches the temperature change waveform for fluctuating operation, an automatic changeover switch which determines whether the temperature width and the time width should be combined automatically or manually, volumes of the temperature width and the time width of fluctuation, etc., besides a faucet switch and a shower switch. Thus, the temperature of supply hot water is fluctuated and its variation is most suitably combined to supply hot water.

In still a further example Japanese Patent Publication No. 1203842 describes a method to make it possible to supply hot water to a faucet or to a shower even during hot water filling and to improve convenience for use by switching one flow passage to the other flow passage to automatically supply hot water during the hot water supply to a bathtub flow passage, automatically switching to the bathtub flow passage with the termination of the hot water supply, and making it possible to resume the hot water supply under the initial bathtub hot water supply condition. When hot water is desired to be supplied to a faucet flow passage 17 during filling a bathtub 23 with hot water, a faucet hot water supply button 52 is pushed to instruct hot water supply to the faucet. A set hot water quantity (instantaneous/integrated), a set hot water temperature, present integrated and instantaneous hot water supply quantities, and a present supply hot water temperature, are stored in a memory 27c in a controller, and a flow rate adjustment-water stoppage changeover valve C is switched to the faucet side. Hot water supply to the faucet 24 is started through a faucet flow path 17, and the hot water supply is continued while performing a suitable temperature control. When the hot water supplying operation is terminated, a faucet hot water supply button 52 is again pushed to stop the hot water supply to the faucet. Within a time set by a timer, the flow rate adjustment-stoppage of water changeover valve C is switched to the bathtub flow path 16, and the stored hot water supply condition is read out and hot water supply to the bathtub 23 is carried out.

In still a further example Japanese Patent Publication No. 59173649 describes a method of providing a massage effect by means of changing the flow rate at the time of shower usage by actuating an actuator to change the flow rate with time which modulates the flow rate setting of a flow rate controller by a signal which varies with time that controls the flow rate in a heat exchanger. Flow rate controller 1 having an actuator 17 is connected to a heat exchanger 11, and a heater 20 for the heat exchanger 11 and a heater controller 19 for said heater 20 are provided. While the temperature of the delivered hot water is detected by a temperature sensor 12, a hot water supply controller 21 outputs a signal to a flow rate controller 1 to switch a variable control of flow rate with time and a constant flow rate control back and forth over a desired time period. That is, the actuator which modulates the flow rate setting of the flow rate controller is actuated by a signal which varies with time so that the flow rate may vary with time, and as a result a message effect is provided at the time of the shower usage by the flow rate change.

### SUMMARY OF THE INVENTION

It is therefore an object of the present invention to provide a means that enables water use to be controlled or that will at least provide the public with a useful choice.

Accordingly, in a first aspect the present invention may be broadly said to consist in a system for controlling a flow of water comprising: a solenoid controllable valve adapted for connection in series with a water line having a user operable control flow means for conveying heated water, wherein the valve is adapted to be operated by a solenoid such that when the solenoid is de-energised the valve is in a normally open state, and when the solenoid is energised the valve is in a closed state, a flow detector adapted to sense water flow in the water line, and a controller adapted for communication with the flow detector and solenoid, wherein the controller is adapted to monitor water flow using the flow detector and is adapted to operate the solenoid controllable valve, wherein in response to detection of water flow the controller is programmed to determine a no flow condition whereby the controller communicates with the solenoid controllable valve to operate the solenoid controllable valve from a normally open position to a closed position for part of a no flow period by energising the solenoid

Preferably, during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

Preferably, the controller is programmed to determine a no flow condition occurs when the controller detects water flow has occurred for a predetermined time in the water line.

Preferably, the controller is programmed to determine a no flow condition occurs when a certain volume of water has flowed in the water line.

Preferably, the controller has determined a no flow condition the controller retains the solenoid controllable valve in the open state if it does not detect water flow in the water line.

Preferably, the controller is adapted to determine a flow condition wherein the controller is programmed to communicate the solenoid controllable valve to de-energise the solenoid to open the solenoid controllable valve during a flow period.

Preferably, the controller determines the no flow condition occurs once a no flow period has expired.

Preferably, the controller comprises a processor.

Preferably, the controller comprises a timer.

Preferably, the user operable control flow means faucet or tap.

In another aspect the present invention may be broadly said to consist in a system for controlling a flow of water comprising: a solenoid controllable valve adapted connected in series with a water line having a user operable control flow means for conveying heated water, wherein the valve is adapted to be operated by a solenoid such that when the solenoid is de-energised the valve is in a normally open state, and when the solenoid is energised the valve is in a closed state, a flow detector installed in or near the water line and adapted to sense water flow in the water line, and a controller communicating with the flow detector and solenoid, wherein the controller is adapted to monitor water flow using the flow detector and is adapted to operate the solenoid controllable valve, wherein in response to detection of water flow the controller is programmed to determine a no flow condition whereby the controller operates the solenoid controllable valve from a normally open position to a closed position for part of a no flow period by energising the solenoid.

Preferably, during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

In another aspect the present invention may be broadly said to consist in controller for controlling a flow of heated water in a water line with a user operable valve, the controller adapted to: communicate with a flow detector adapted to sense the water line to detect water flow in the water line, and communicate with a solenoid controllable valve adapted for connection in series with a water line having a user operable valve for conveying heated water, and adapted to be operated by a solenoid such that when the solenoid is de-energised the valve is in a normally open state, and when the solenoid is energised the valve is in a closed state, wherein in response to detection of water flow the controller is programmed to determine a no flow condition whereby the controller is adapted to operate the solenoid controllable valve from a normally open position to a closed position for part of a no flow period by energising the solenoid.

Preferably, during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

In another aspect the present invention may be broadly said to consist in a valve assembly for controlling a flow of heated water in a water line with a user operable valve, the valve comprising: a solenoid controllable valve adapted for connection in series with a water line having a user operable valve for conveying heated water, wherein the valve is adapted to be operated by a solenoid such that when the solenoid is de-energised the valve is in a normally open state, and when the solenoid is energised the valve is in a closed state, a flow detector adapted to sense the water line to detect water flow in the water line, wherein the solenoid is adapted for use with a controller that is adapted to communicate with the flow detector to monitor water flow, the controller in response to detection of water flow the controller is programmed to determine a no flow condition whereby the controller is adapted to operate the solenoid controllable valve from a normally open position to a closed position for part of a no flow period by energising the solenoid.

Preferably, during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

In another aspect the present invention may be broadly said to consist in a controller for varying a flow of water comprising: a valve configured to close or open depending on a control input, and in use connected in series with a heated water line conveying said flow of water, a flow detection means providing an indication of said flow of water, and a timer or processor receiving said indication of flow and after a predetermined flow period providing a signal to said valve to operate said valve from a normally open position to a closed position for a predetermined no flow period.

In another aspect the present invention may be said to consist in a controller for varying a flow of water comprising: a valve configured to close or open depending on a control input, and in use connected in series with a heated water line conveying said flow of water, a flow detection means providing an indication of said flow of water, and a timer or processor receiving said indication of flow and after a predetermined indication period providing a signal to an indicator and/or said valve to operate said valve to indicate to a user the flow will soon be closed.

In another aspect the present invention may be broadly said to consist in a controller for varying a flow of water comprising: a valve configured to close or open depending on a control input, and in use connected in series with a heated water line conveying said flow of water, a flow detection means providing an indication of said flow of water, and a timer or processor receiving said indication of flow and after a predetermined flow period providing a signal to said valve to operate said valve from a normally open position to a closed position for a predetermined no flow period, an input configured to receive a code or identifier, or with a security cover whereby at least said predetermined periods are able to be varied using said input once said code or ID is correctly entered, or said security cover is removed.

Preferably said valve is located on a single output water line by for example directly connected to a shower, bath califont or hot water supply line.

Alternatively said valve is connected to a line with several outputs wherein at least one is a major flow output e.g. shower and said timer includes a predetermined discrimination period whereby flow for less than the predetermined discrimination period is ignored and the timer is not started.

Preferably said controller further comprising a proportional valve configured to limit or vary the maximum flow through said heated water line.

Preferably said valve and said flow detection means operate on local utility supply voltage.

Preferably said valve is a normally open solenoid valve and fails open, ensuring cold water is always available in an emergency situation, e.g. during power outages and for family safety.

Preferably said controller further comprising a temperature sensor and wherein the output of said sensor is provided to said timer and wherein said predetermined flow period will not begin unless the temperature is above a predetermined level.

Preferably said valve and said flow switch operate on 240 volt.

Preferably said valve is a normally open solenoid valve.

Preferably said normally open solenoid valve includes a manual over ride.

Preferably said flow switch is a magnetic paddle type.

Preferably said controller includes a further input allowing operation of said valve depending on the signal supplied to said input, for hot water cut-off to prevent access to further hot water supplies

Preferably said indication comprises at least one pulse of the hot water flow to indicate end of shower time programmed.

Preferably said indication comprises a predetermined number of pulses over a predetermined period.

Preferably each said period may be varied by user input means.

In another aspect the present invention may be broadly said to consist in a controller for varying a flow of water comprising: a valve configured to close or open depending on a control input, and in use connected in series with a heated water line conveying said flow of water, said heated line including a faucet, wherein the valve is adapted to be operated by way of a solenoid such that when the solenoid is de-energised the valve is in the open state, and when the solenoid is de-energised the valve is in a closed state, a flow detection means providing an indication of said flow of water, and a timer or processor receiving said indication of flow and after a predetermined flow period providing a signal to operate said valve from a normally open position to a closed position for part of a predetermined no flow period by energising the solenoid.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

One preferred form of the present invention will now be described with reference to the accompanying drawings in which;

FIG. 1 is a schematic diagram of the electrical and water system according to the present invention.

FIG. 2 is a schematic diagram of the electrical and water system according to an alternative embodiment of the present invention.

FIG. 3a is a front view of a control panel.

FIG. 3b is a front view of an alternative control panel.

FIGS. 4a and 4b are flow diagrams showing the control logic of first and second embodiments of the invention.

FIGS. 5a and 5b are a wiring diagram of the system.

FIG. 6 is a circuit diagram of the second embodiment of the controller.

### DETAILED DESCRIPTION

### Brief Overview

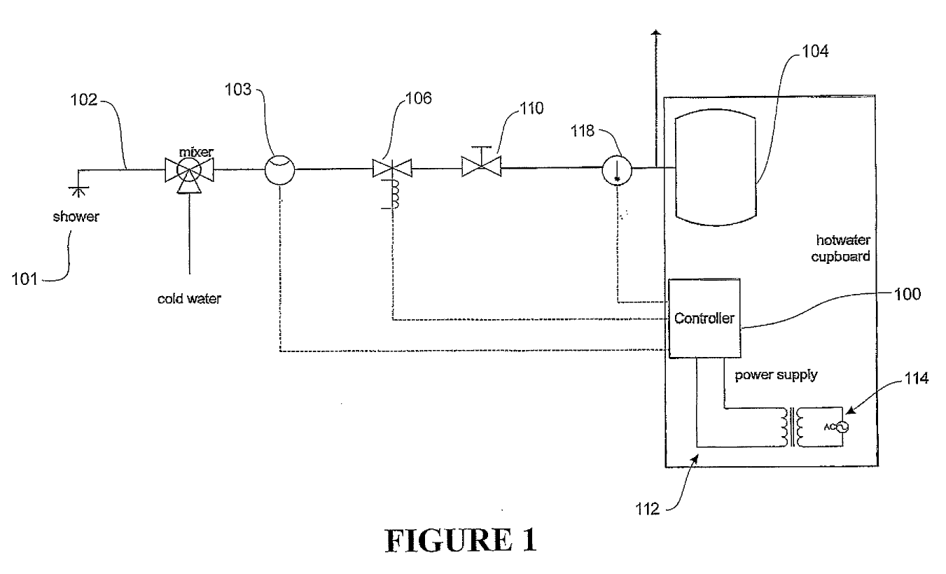

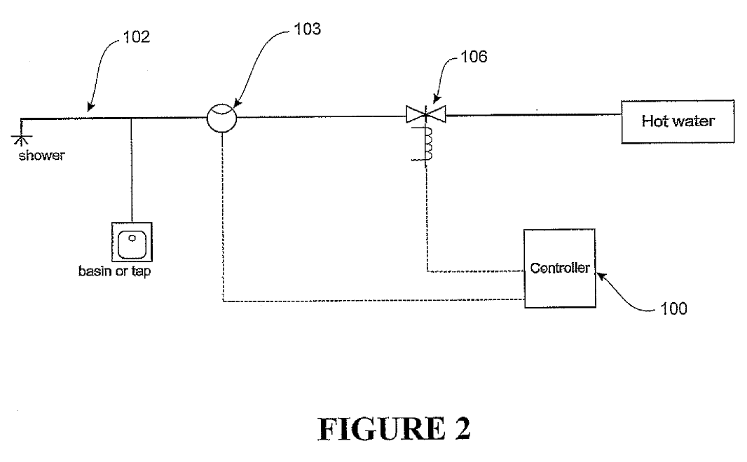

A preferred embodiment of the invention is shown in FIG. 1-5b. The invention relates to a system comprising constituent components that can be installed to enable control of heated water use in baths, showers, basins or other water dispensing situations in which heated water is used. The invention can be retrofitted into existing water dispensing installations, or included in or integrally formed with new installations. The invention is adapted to be installed in water dispensing installations supplied by hot water cylinders or similar for producing and providing hot water. Alternatively, the invention could be used in a water dispensing installation where instant hot water heating is used, such as califont. It will be appreciated that the terms “hot water” and “heated water” refer to any water that has been heated to any temperature.

The system is preferably in two parts. First it has a control valve and flow detection means placed as closed to the shower mixer or other outlet as is practical. Second a controller installed near the hot water cylinder or other supply, where mains power is usually available and is safe from tampering.

A preferred embodiment of the invention enables control of heated or hot water in the following manner. The invention facilates a flow period which is a time period in which the hot water is permitted to be used in the water dispensing installation. It will be appreciated that in fact heated water may or may not actually be used during a flow period. The invention also facilitates a no flow period which is a time period in which use of hot water is temporarily restricted. During the flow period, the invention operates to allow a user to utilise hot water at their discretion. During the no flow period the invention operates to prevent a user from using hot water.

In a preferred embodiment, the no flow period occurs after use of hot water has been undertaken during a flow period where hot water is permitted to be used. The no flow period preferably occurs after a period of time of hot water use has elapsed during the flow period, and more preferably a predetermined or preset period of time. Alternatively, the no flow period might occur after some other parameter or event has occurred, such as when flow of a certain volume of heated water has occurred.

Once the flow period has finished the invention goes into a no flow state whereby it prevents use of heated water for a no flow period. Once the no flow period is over, the invention determines a flow condition and re-establishes a flow period that allows use of hot water once again. The no flow period is preferably a time period, which preferably is predetermined or preset by someone controlling or managing the system. This, for example, could be a household owner, hotel manager or any other person responsible for the shower, bath, basin or other water dispensing installation in which the invention is installed. The flow period whereby use of hot water is permitted is generally not restricted to a particular length of time. The invention maintains a flow period until an event occurs. For example, once someone makes use of hot water during a flow period this triggers a water usage period which once it expires puts the system into a no flow state or condition.

FIG. 1 shows in diagrammatic form a shower installation including installed components for a water control system in accordance with a preferred embodiment of the invention. Referring to FIG. 1, a plumber and electrician can fit the present invention components into the hot water/shower supply line 102. These components comprise a solenoid controlled valve 106, a flow detections means 103 and/or a temperature sensor 108 and a controller 100 for controlling the system. The hot water supply line provides hot water between the hot water cylinder 104 or similar heated water reservoir or supply and the shower head 101 or other water outlet means. The controller 100 can also be programmed to operate in accordance with the requirements of the system manager, after installation into the existing hot water system 104. Preferably the components are of solid state circuitry with low voltage activation, e.g. 24 volt running off 240 volt AC supply. A transformer is provided in the controller to convert the voltage. The controller is supplied through a transformer 112 from the AC supply 114. The controller 100 monitors the flow of hot water and the maximum length of the shower to assist in reducing water heating bills and reduce the possibility of cold showers. In a preferred embodiment, the valve 106 would be provide as one unit, and the controller as a separate unit, ready for installation. The valve unit could also optionally include a temperature sensor 108, flow detection means 106 and/or flow reduction valve.

A preferred embodiment of the invention is shown in FIG. 1. The components shown in FIG. 1 include the controller 100, solenoid shut-off valve 106, flow switch or flow detection means 103 and temperature sensor 108. A faucet, tap 110 other user controlled flow means is provided in the hot water supply line 102, between the hot water cylinder and solenoid valve 106. This faucet, tap or the like 110 enables a user to control flow of water in the heated water line 102. Controller 100 may be a microprocessor, ASIC or other processing device which receives the flow information from the detection means 103 and/or temperature sensor 108 and operates the valve 106 in accordance with the water supply programme set by the system manager. The controller 100 includes input means to allow the parameters to be varied and optionally a display. Shut off valve 106 is a normally open solenoid activated valve. This means it defaults to a failsafe open position, allowing flow of water. The solenoid of the valve 106 does not draw power in the normally open state, and defaults to this position when it is de-energised. Optionally it includes an external manual override. Flow switch/detection means 103 or temperature sensor 108 provide flow information. By sensing the temperature of the water in the supply line, the temperature sensor 108 can detect if hot water is flowing. When the temperature is above a certain threshold flow is detected. Therefore the temperature sensor 108 can act as a flow detection means also. Flow detection means 103 is optionally a magnetic paddle type. Other methods of water flow/flow detection are equally applicable and will be contemplated by one skilled in the art as incorporated into this description. Preferably, the control valve 106 and flow detection means 103 and/or temperature sensor are located near the shower facility, and a controller including timer is located in the hot water cylinder cupboard or near the storage cylinder where utility power is usually available and is sufficiently removed from tampering.

The controller 100 controls flow of water through the supply line 102 in accordance with a preferably predetermined program. The controller 100 determines when a no flow condition occurs which relates to a no flow period in which use or supply of heated water is not permitted. The controller 100 also determines a flow condition that relates to a flow period in which use of heated water is permitted or permitted to be supplied. When the controller 100 determines a no flow condition relating to a no flow period it operates the solenoid controllable valve 106 to prevent water flowing through to the shower head 101 or other water outlet. When a flow condition occurs relating to a flow period the controller 100 operates the solenoid controllable valve 106 into an open position to allow heated water to flow through to the water outlet 101. The no flow period occurs for a period of time, that is preferably predetermined by user input. Once the no flow condition is initially detected by the controller, the controller triggers a timer which is used to determine when the no flow period expires. When the no flow period expires the controller 100 goes into a flow condition which then activates the controller to operate the valve 106 to allow heated water flow. During this time the user is free to operate the user control flow means to access heated water as desired. When heated water is supplied due to the user operating a user control flow means such as a faucet 110, the controller 100 will detect flow of water by way of a flow detection means 103 and/or temperature sensor 108 to which it is connected to and in communication with. Once flow is detected this triggers a timer. The invention permits use or supply of the heated water for a, preferably predetermined, time set by someone in control of the invention. Once that predetermined time has expired, the controller 100 determines that a no flow condition occurs and that a no flow period should commence. This then triggers the controller to close the valve mentioned previously. Alternatively, the flow period might cease when a certain volume of water has been used, determined by the controller from the flow detection means and/or temperature sensor. Other metrics for determining when the flow period should end might also be envisaged by those skilled in the art.

In summary of a preferred operation of the invention, at first the system will be in a flow period. A user opens the faucet 110 to supply hot water to the shower head 101 or other water outlet. At this point, the solenoid valve 106 will be in the de-energised default normally open position, allowing water to flow through the valve 106 to the shower head 101. The flow detection means 103 and/or temperature sensor 108 detect the water flow and trigger the controller 100 to start the timing process, which will be explained in further detail below. Once the controller determines that flow should stop (i.e. that the flow period should cease), it energises the solenoid valve 106 such that it closes and blocks the flow of water. At this point or soon after, generally the user of the shower will close the faucet 110, thus also preventing water reaching the shower head 101. Eventually, in a manner to be described below, the solenoid valve 106 re-opens for at least part of the no flow period, when the faucet is closed. In this manner, the solenoid valve 106 is in a de-energised state, thus conserving energy for the majority of the time. The operation means that the solenoid of the valve is only energized into a closed state only for a small time, thus reducing energy consumption and improving the life span of the solenoid.

Prior to closing the valve 106 during the no flow period, the valve may be operated in a manner described below, to pulse the hot water indicating that the shower on time is coming to an end. Alternative means of indicating that heated water flow will cease can be provided. Now referring to the process that occurs when the valve initially closes during the initial stages of the no flow period. At the completion of a warning cycle the valve is closed and held closed. Generally at this point or soon after the faucet 110 is closed by the bather stopping flow. The control valve 106 is turned off of by the controller by de-energising the solenoid, thereby saving energy and keeping the solenoid valve cool, thereby prolonging its life. If the control faucet 110 is opened within the no flow period, the control valve 106 is reactivated by energising the solenoid to stop water flowing. This may repeat several times until the stop (no flow) period has expired, thereafter the controller checks every several seconds to determine if water has re-begun to flow.

### Setup of Controller

In one embodiment, the shower controller 100 is set up using the three buttons or control knobs on the front panel, which displays on a backlit LCD panel.

The procedure is initiated by holding down the setup button (located in the centre of the controller) for 20 seconds while the unit is in the “READY” mode.

When the controller 100 is in the set up mode, set up items are selected by pressing the set up button again. The left and right buttons are used to increment and decrement value selections as required.

The set up mode automatically terminates if no button is pressed for 60 seconds, or the EXIT item's value is changed from 0 to 1.

To change the pin number, the right and centre buttons are pressed for several seconds together which opens another setup mode allowing access to alter the pin number and restore the factory default settings.

Items displayed on the panel are as follows:

### Shower Controller

| Display | Item | Selections | | Default | Comment |
|---|---|---|---|---|---|
| PIN | Pin number | 0-9999 | | 1 | Used to prevent unauthorized |
| | | | | | Access to setup items. |
| SOTM | Shower maximum | 0-20 | Min | 6 | Maximum shower duration. |
| | time | | | | |
| ENDM | Duration of first pulse. | 1-59 | Sec | 1 | Approaching the last minute of a |
| ENDS | Duration of second | 1-59 | sec | 1 | shower, the hot water is turned off and |
| | pulse. | | | | on again, creating a pulsing effect. This |
| ENDR | Number of cycles | 1-10 | | 1 | warns the user that 60 seconds remain |
| | | | | | until the end of the shower time, as |
| | | | | | programmed. |
| SRTM | Shower rest time | 0-20 | min | 2 | Minimum time between showers |

| | | | | |
|---|---|---|---|---|
| EXIT | Exit from Set up mode | 1-Exit | 0 | Set to 1 to exit |

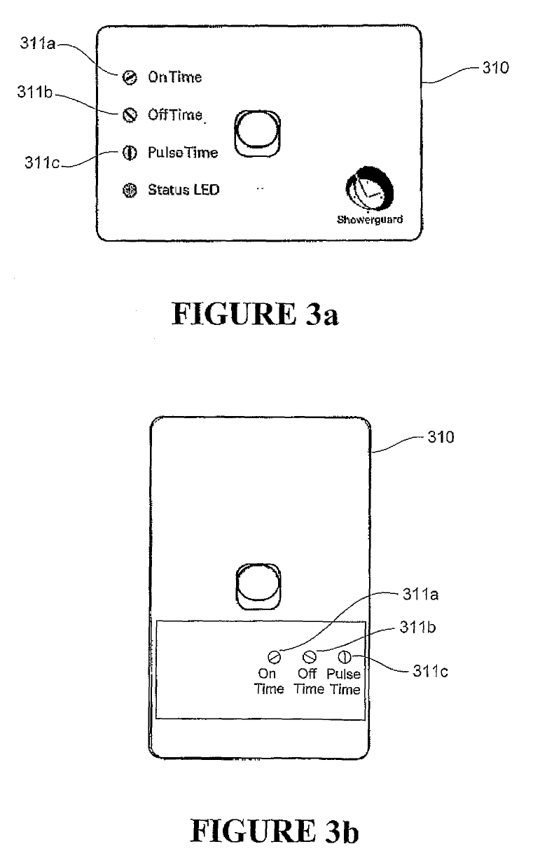

In an alternative embodiment, as shown in FIGS. 3a and 3b a different type of controller user interface 310 is implemented. In this embodiment, the shower controller 100 is set up using three screwdriver adjustable potentiometers 311a-311c or other control knobs under the front cover plate of the switch unit. The three potentiometers adjust the on time (On Time) 311a, the time between showers (Rest or Off Time) 311b, and the frequency and duration of low temperature warning flow pulses prior to shut off (Pulse Time) 311c. The ranges of the times could be as in the table above, or alternatively as below:

### On Time 3-20 Minutes

### Off/Rest Time 1-20 Minutes

### Pulse Time 1-20 Seconds,

Or any other suitable ranges of on/off/pulse times could be implemented by those skilled in the art. A status indicator, such as an LED 311d indicates what state the controller is in.
The set up configurations are input by someone that manages the shower, e.g. house owner, hotel owner or the like. A security code, key or other security means could be used to prevent unauthorized people from altering the settings.

### Operation Embodiment 1

This operation relates to the embodiment shown in FIG. 7 which has no faucet upstream of the control valve. When the controller 100 of is in rest mode (flow mode or period) with no shower operating, it displays READY on its front display, and the time since the last shower. Alternatively it indicates this by other means such as an LED. The solenoid valve 106 is open, and the faucet 110 is closed. When the controller 100 detects hot water flow, it starts a timer, step 404, which after the shower on time (SOTM) determines a no flow condition and turns off the hot water flow by closing the solenoid valve 106. This starts the no flow period. Flow may be detected by flow switch/detection means 103 or temperature sensor 108. Approaching the last minute of a shower (or some other suitable prior warming period), and prior to full shut off of the solenoid valve 106, the hot water is turned off and on again, creating a pulsing effect. This is achieved by the controller 100 energising and de-energising the solenoid of the valve 106, in order to open and close it to control hot water flow to the shower head. This pulse mode is implemented by the controller in accordance with the length of time and the number of pulses specified by the programme or configurations entered into the controller. This warns the user that sixty seconds remain until the end of the shower time as programmed. It would be clear that a different length of warning period could be used, for example 30 seconds or two minutes. A flashing LED or other warning mechanism could be used instead.

The display shows SHWR ON, and the remaining shower time in minutes, and seconds. Another indicator of shower on could be provided, such as an LED. Once the shower has been turned off by closing the valve 106 the hot water is prevented from flowing for the SRTM (shower rest time or off time) time, step 408. The display shows SHWR RST, and the time in minutes and seconds until the shower is once again available for use. Another means could be used, such as an LED. In this time, the solenoid valve 106 will be energized by the controller 100 in order to keep it in the closed state.

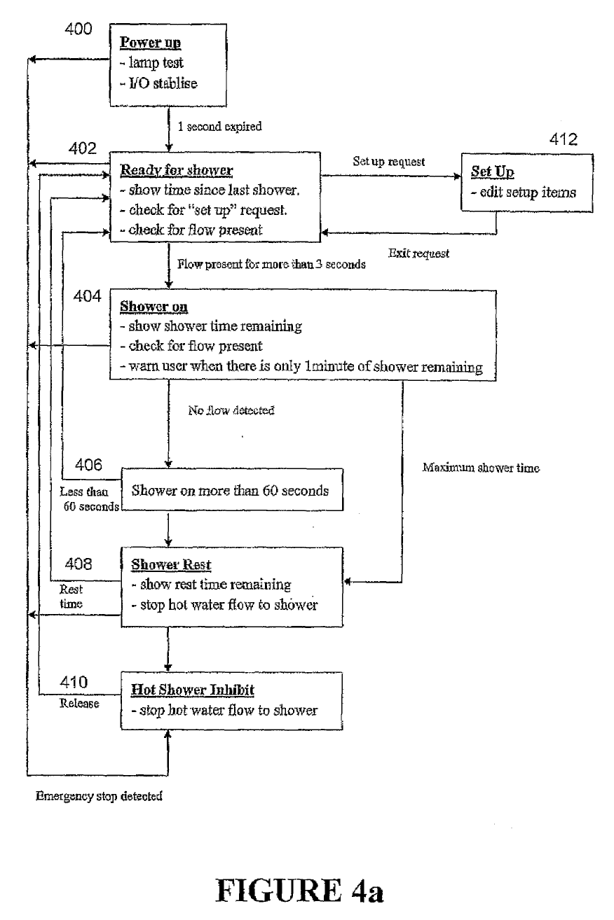

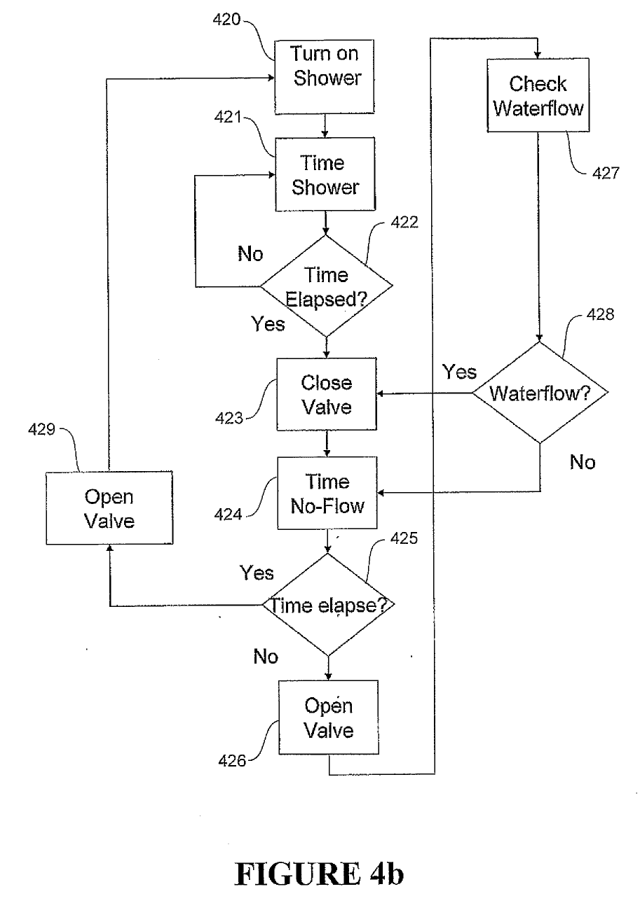

Referring to FIG. 4 the logic used by the controller is depicted. Initially under power up 400 the lamps are tested and input and output are stabilized. After a second the system is ready for operation 402 and displays time since last shower, checks for set up requests and checks for flow.

With a set up request 412 editing of set up items, parameters etc is available.

If flow is present for more than three seconds the shower is considered on 404. The controller shows shower time remaining, checks for flow and warns the user when there is only one minute remaining. If no flow is detected indicating a shower of less than 60 seconds the controller resets 406 to ready for next shower. If the maximum time is reached the hot water is shut off 408 via control of the valve 106 and the period of time until the next shower is permitted is displayed. Prior to shut off 408, the hot water is pulsed as described above. Optionally hot water may be inhibited 410 by a further input which may be provided for example by a timer to prevent hot showers over certain periods.

### Operation Embodiment 2

Operation of the second embodiment is as follows. The second embodiment has a controller with face plates as shown in FIG. 3a or 3b. When the controller 100 is in ready mode (which corresponds to flow mode—that is that flow or supply of hot water is permitted) the shower or bath or other water supply area is then ready for the user to commence flow by turning the faucet on, step 420. When the controller is in Ready mode (flow mode), as per the controller in FIG. 3a or 3b, with no shower operating and the controller switched on, the LED on the front panel flashes briefly once every 10 seconds. When the shower is turned on by a user, step 420, turning on the faucet and hot water flows, then the LED turns on until 1 minute before the end of the shower On Time. At this point the controller triggers the timer to determine when the no flow period should start. Flow is detected by the flow means 103 and/or temperature sensor 108. The controller 100 might wait for a certain time (e.g. 10 seconds) of flow before determining that flow has started and triggering the timer. This discrimination period prevents unnecessarily restricting use if someone only briefly turns on the faucet. For the last minute of shower On Time (i.e. one minute in this case), the controller operates the solenoid valve 106 to turn it off for the duration of the Pulse Time, and turn it on again for the duration of the Pulse Time. During this period, the LED flashes quickly, for example once every 0.5 seconds.

When the shower time has expired, step 422, the flow solenoid valve 106 is turned on for 30 seconds, cutting off the hot water, step 423. A no flow timer is then started, step 424. It then checks if the no flow period expires, step 425. If not, the valve 106 is briefly turned on again after 30 seconds, step 426, and the flow detection means 103 and/or temperature sensor 108 is monitored and if hot water flow is detected, step 427, step 428 (i.e if the faucet 110 is still open or has been reopened), the solenoid valve 106 is closed again for 10 seconds and then re-opened, step 423, step 426. Monitoring of flow in the heated water line 102 then takes place again, step 427. The process of detecting flow and operating the solenoid valve 106 between on and off states continues for the duration of the shower Off Time (no flow period). In this way, it ensures the shower stays off for the entire time, even if the user doesn't turn off the faucet 110, or someone else turns on the faucet 110 before the shower Off Time expires. However, it also ensures that the solenoid is not unnecessarily kept energized (ie the valve 106 put into the closed position by energizing the solenoid) during the shower Off Time, if the faucet 110 is closed. Therefore the valve 106 may open/close multiple times during the no flow period. During the shower Rest Time, the LED flashes slowly. Once the show Off Time has expired, step 425, the controller determines that the flow condition has re-occurred and the flow period should start again. The controller de-energises the solenoid, step 429 thus opening the valve 106, and allowing a user to use heated water again by opening the faucet, step 420. The LED resumes its brief flash every 10 seconds until flow is detected. A similar process can be implemented with the first type of controller shown in FIG. 3a.

Preferably, if a user turns off the faucet 110 before their shower time expires, the controller goes into a no flow condition, and starts the no flow period. It will be appreciated that other alternatives to this are possible. For example, the shower might be operational for another shower until the time for the original shower would have expired.

It will be appreciated that the times mentioned above are exemplary, and other suitable times could be implemented.

### Installation of Embodiment 2

The plumber connects the following into the shower hot water supply pipe work as near as possible to the mixer being monitored, either by crimping or fitting crox nuts as required:
a) Flow detection device.
b) Solenoid shutoff valve as preferably one unit.

The electrician connects the following:
a) Cables feeding back to a controller in the hot water cylinder cupboard.
b) The controller to the electrical supply, using conventional flush boxes and flush plates and standard electrical fittings and wiring practice.
   The operator/owner preferably programmes the unit by removing the face plate from the electrical controller to set the required time intervals as follows. Note that the face plate might be colour coded to assist the user. For example, portion of the face plate near or around the on time adjustment knob could be green. The portion of the face plate near or around the pulse time adjustment knob could be yellow. The portion of the face plate near or around the off time adjustment knob could be red. The face plate might include colour code instructions on how to set each setting, for example as set out below. Other colour schemes could be envisaged, or no colours used at all. Where green, yellow and red are used,

Green

1. A 3-20 minute maximum shower duration time.

(On Time Sets the Maximum Shower Duration.)

Yellow

2. A 1-20 second pulse time.

(Pulse Time sets the cold water pulse which warns
The user there is one minute left before the shower ends.)

Red

3. A 1-20 minute rest time
(Off Time Sets the Waiting Period Between Showers)
   It will be appreciated that these times are exemplary only, and other could be envisaged.
   The programmable pulse duration time can be adjusted by the owner to allow several seconds of pulsing, warning the user that only 60 seconds remain before the shower ends. Other durations could be envisaged. Optionally, some security device or pin could be used to prevent unauthorized configuration.

### System Configuration of Embodiment 1

### To Programme the Unit by Setting:

a) Security pin from 1-9999.

b) 2-30 minute shower duration time.

c) 2-30 minute shower rest time.

d) 1-10 second pulses and up to ten repeat cycles.

The security pin is an option that may or may not be used.

The programmable pulse duration time, can be adjusted by the owner to allow several seconds of pulsing, warning the user that sixty seconds remain until the shower ends.

It will be appreciated that the above embodiments relate to use in a shower. It would be readily understood by those skilled in the art that the invention could be installed in other water provision systems such as baths, basins and the like in a similar manner. It will also be appreciated that the invention could be applied in the case of instant water heating installations such as a califont.

In another embodiment the controller can be programmed to upload data on hot water use to a computer for monitoring usage.

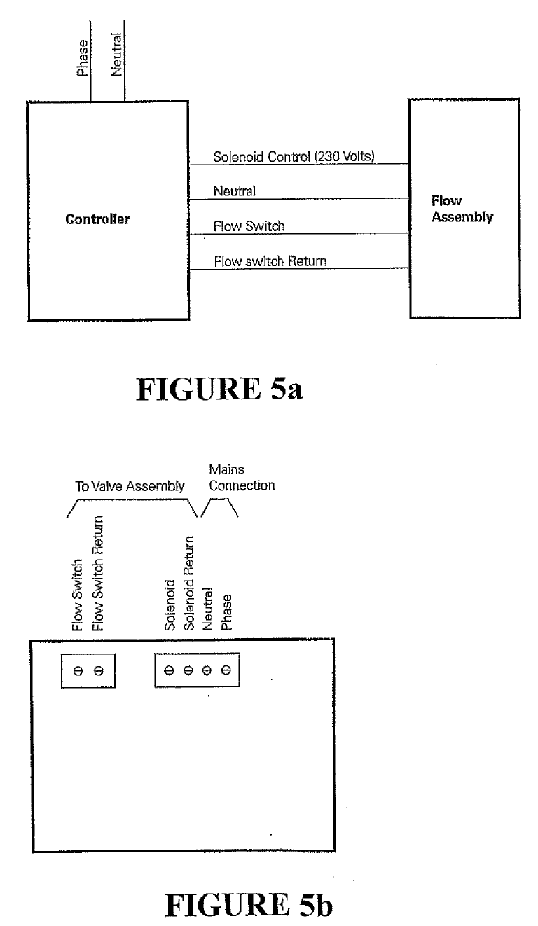

FIGS. 5a and 5b show the diagrammatic interconnection of the controller 100 and the flow assembly for embodiment 2, shown in FIGS. 3a, 3b. The flow assembly includes the solenoid controllable valve 106 and also optionally the flow detection means 103 and/or the temperature sensor. It may also include the flow reduction valve. FIG. 5b shows in further detail the connections on the controller. The controller is connected to the phase neutral of an AC power supply 51, 52. A solenoid control line that provides power to the solenoid is provided between the controller and solenoid 53. A neutral line 54 is also provided. A signal line and return line 55, 56 provided for control signals coming from the controller 100 to operate the flow assembly.

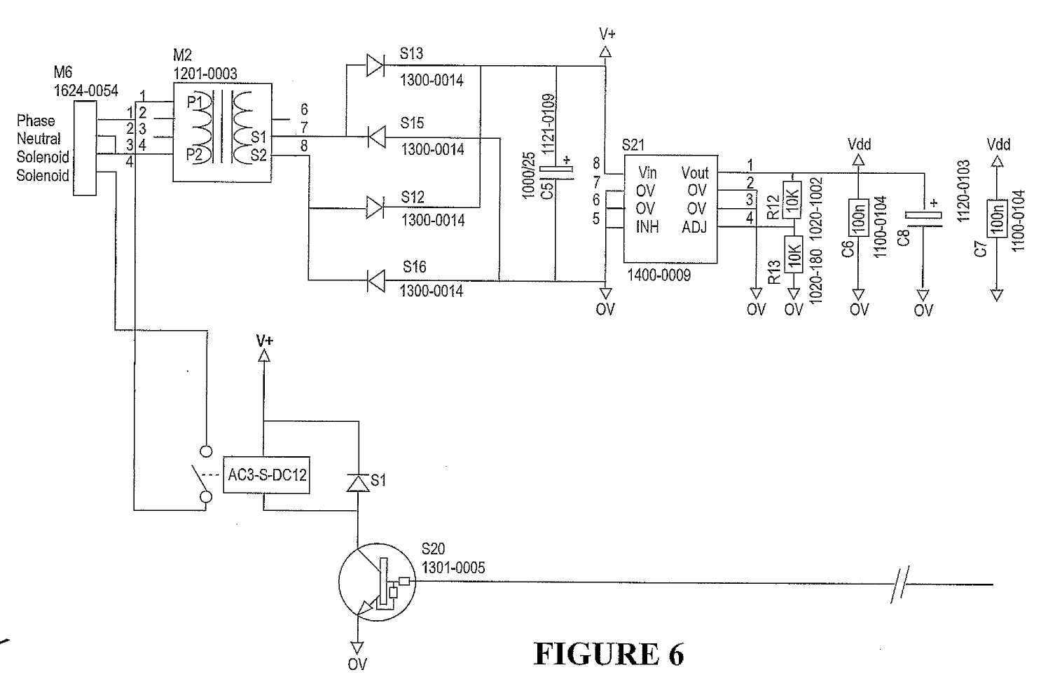

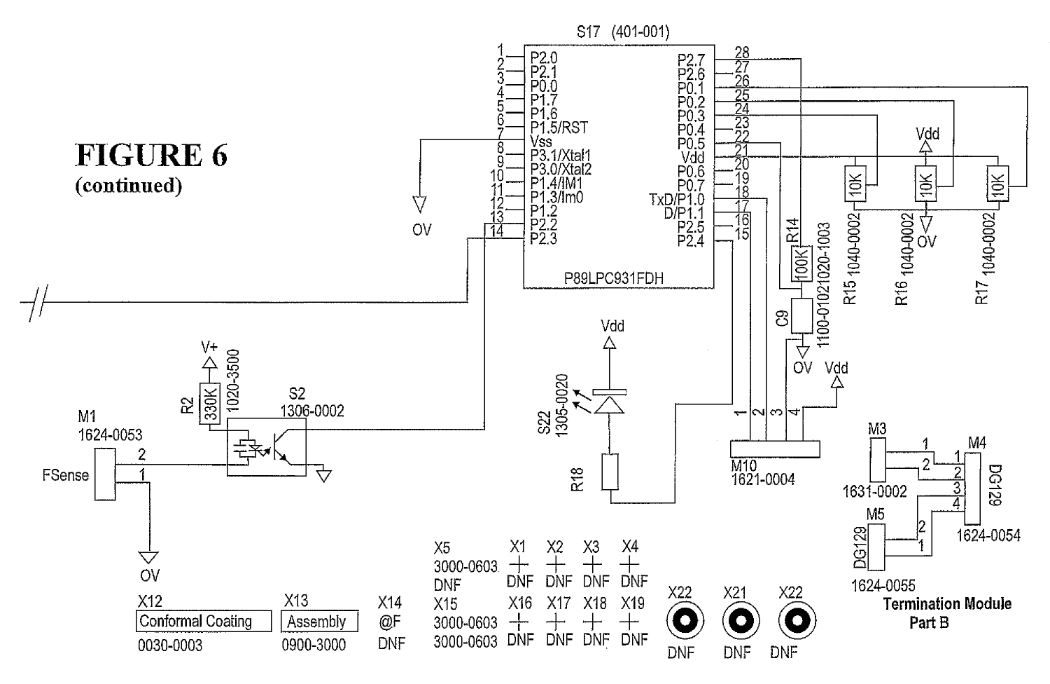

FIG. 6 shows a circuit diagram of the second embodiment of the controller.

### Considerations

In new houses, the preferred solution would be to install controller directly at the hot water cylinders on a separate supply line to the shower being monitored.

In order to reduce shower water volume to a conservation level i.e. 7-9 litres a minute, a manual gate valve 110 could be installed (after the solenoid valve), at the time of fitting, this can be adjusted easily by the owner if required to increase or decrease the hot water flow, thereby reducing the overall water volume. This replaces the need for water saving shower head, and the difficulties the supply and installation of that represent.

The present invention is designed to encourage the family to be conservation conscious in the bathroom, in the use of water and the energy used to heat it. By minimizing domestic hot water and energy use in this way, every family using. The present invention can save up to one third of what it currently spends on its water and water heating bills, with the added benefit of a more even distribution of those resources among the whole family.

To save water and the electricity or gas used to heat it, by monitoring the shower time for each family member and reducing it to less than 10 minutes.

For a family of four this reduction in shower time could result in a saving of 400-800 litres of water a day. (A 20 minute shower uses 200 litres of hot water; a seven minute shower only 70). Such savings add up to two million litres of hot water a year, plus a reduction in water heating costs of up to one third.

In a city like Auckland, New Zealand, or Sydney, Australia the use of control system to reduce water and heating costs in homes could result in saving billions of litres of water each year; and this would be much more if the control system were applied to commercial hot water usage as well.

Wherever there is a need to monitor the use of hot water, whether in industry, shopping malls, or any commercial or domestic location, it is obvious that there will be cost benefits for both local and national economies wherever the control system is introduced.

The introduction of the control system to conserve water and energy would enable authorities to maximise existing resources rather than have to pursue the development of new sources of energy in the face of growing public resistance, especially where the burning of fossil fuels could result in air pollution or land would be flooded behind new hydro dams.

Preferably, the control system can be programmed to upload data to the home owner's PC on hot water use. The software can be updated by a registered installer onsite, and can be used to monitor shower use in motels, hotels, hostels and the like, and vacant suites to deter errant staff use. It can be used to monitor the use of shower water by family members as a means to keep an eye on the health and movement of other family members or the like.

Preferably the invention enables fair and equitable use of hot water through a shower mixer, bath or califont. It can also function as a device for controlling errant consumers of hot water in apartments, enabling restriction of their hot water supply by the supply authority in the event of their failure to pay gas/electric heating accounts. In addition, the device could be used to monitor hot water use in rest homes and upload data via a PC to control work stations for an overview of bathing habits among elderly. It is designed for retrofitting and with the fitting of a gate valve can be set to adjust shower water volume to an acceptable level, e.g. 10 L/min by the user without the need for a low flow shower rose.

1. A system for controlling a flow of water comprising:
a solenoid controllable valve adapted for connection in series with a water line having a user operable control flow means for conveying heated water, wherein the valve is adapted to be operated by a solenoid such that when the solenoid is de-energised the valve is in a normally open state, and when the solenoid is energised the valve is in a closed state,
a flow detector adapted to sense water flow in the water line, and
a controller adapted for communication with the flow detector and solenoid, wherein the controller is adapted to monitor water flow using the flow detector and is adapted to operate the solenoid controllable valve,
wherein in response to detection of water flow the controller is programmed to determine a no flow condition whereby the controller communicates with the solenoid controllable valve to operate the solenoid controllable valve from a normally open position to a closed position for part of a no flow period by energising the solenoid.

2. A system according to claim 1 wherein during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

3. A system according to claim 1 wherein the controller is programmed to determine a no flow condition occurs when the controller detects water flow has occurred for a predetermined time in the water line.

4. A system according to claim 1 wherein the controller is programmed to determine a no flow condition occurs when a certain volume of water has flowed in the water line.

5. A system according to claim 4 wherein when the controller has determined a no flow condition the controller retains the solenoid controllable valve in the open state if it does not detect water flow in the water line.

6. A system according to claim 1 wherein the controller is adapted to determine a flow condition wherein the controller is programmed to communicate the solenoid controllable valve to de-energise the solenoid to open the solenoid controllable valve during a flow period.

7. A system according to claim 6 wherein the controller determines the no flow condition occurs once a no flow period has expired.

8. (canceled)

9. A system according to claim 1 wherein the controller comprises a timer.

10. A system according to claim 1 wherein the user operable control flow means faucet or tap.

11. A system for controlling a flow of water comprising:
a solenoid controllable valve connected in series with a water line having a user operable control flow means for conveying heated water, wherein the valve is adapted to be operated by a solenoid such that when the solenoid is de-energised the valve is in a normally open state, and when the solenoid is energised the valve is in a closed state,
a flow detector installed in or near the water line and adapted to sense water flow in the water line, and
a controller communicating with the flow detector and solenoid, wherein the controller is adapted to monitor water flow using the flow detector and is adapted to operate the solenoid controllable valve,
wherein in response to detection of water flow the controller is programmed to determine a no flow condition whereby the controller operates the solenoid controllable valve from a normally open position to a closed position for part of a no flow period by energising the solenoid.

12. A system according to claim 11 wherein during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

13. A controller for controlling a flow of heated water in a water line with a user operable valve, the controller adapted to:
communicate with a flow detector adapted to sense the water line to detect water flow in the water line, and
communicate with a solenoid controllable valve adapted for connection in series with a water line having a user operable valve for conveying heated water, and adapted to be operated by a solenoid such that when the solenoid is de-energised the valve is in a normally open state, and when the solenoid is energised the valve is in a closed state,
wherein in response to detection of water flow the controller is programmed to determine a no flow condition whereby the controller is adapted to operate the solenoid controllable valve from a normally open position to a closed position for part of a no flow period by energising the solenoid.

14. A controller according to claim 13 wherein during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

15. A valve assembly for controlling a flow of heated water in a water line with a user operable valve, the valve comprising:
a solenoid controllable valve adapted for connection in series with a water line having a user operable valve for conveying heated water, wherein the valve is adapted to be operated by a solenoid such that when the solenoid is de-energised the valve is in a normally open state, and when the solenoid is energised the valve is in a closed state,
a flow detector adapted to sense the water line to detect water flow in the water line,
wherein the solenoid is adapted for use with a controller that is adapted to communicate with the flow detector to monitor water flow, the controller in response to detection of water flow the controller is programmed to determine a no flow condition whereby the controller is adapted to operate the solenoid controllable valve from a normally open position to a closed position for part of a no flow period by energising the solenoid.

16. A valve according to claim 15 wherein during a determined no flow period, the controller is programmed to communicate with the solenoid controllable valve to de-energise the solenoid to open the solenoid controllable valve and monitor water flow in the water line, wherein the controller is programmed to energise the solenoid to close the solenoid controllable valve if the controller detects water flow in the water line.

17. A controller for varying a flow of water comprising:
a valve configured to close or open depending on a control input, and in use connected in series with a heated water line conveying said flow of water, said heated line including a faucet, wherein the valve is adapted to be operated by way of a solenoid such that when the solenoid is de-energised the valve is in the open state, and when the solenoid is de-energised the valve is in a closed state,
a flow detection means providing an indication of said flow of water, and
a timer or processor receiving said indication of flow and after a predetermined flow period providing a signal to operate said valve from a normally open position to a closed position for part of a predetermined no flow period by energising the solenoid.

18. A controller for varying a flow of water comprising:
a valve configured to close or open depending on a control input, and in use connected in series with a heated water line conveying said flow of water,
a flow detection means providing an indication of said flow of water, and
a timer or processor receiving said indication of flow and after a predetermined flow period providing a signal to said valve to operate said valve from a normally open position to a closed position for a predetermined no flow period.

19. A controller for varying a flow of water comprising:
a valve configured to close or open depending on a control input, and in use connected in series with a heated water line conveying said flow of water,
a flow detection means providing an indication of said flow of water, and
a timer or processor receiving said indication of flow and after a predetermined indication period providing a signal to an indicator and/or said valve to operate said valve to indicate to a user the flow will soon be closed.

20. A controller for varying a flow of water comprising:
a valve configured to close or open depending on a control input, and in use connected in series with a heated water line conveying said flow of water,
a flow detection means providing an indication of said flow of water, and
a timer or processor receiving said indication of flow and after a predetermined flow period providing a signal to said valve to operate said valve from a normally open position to a closed position for a predetermined no flow period,
an input configured to receive a code or identifier, or with a security cover whereby at least said predetermined periods are able to be varied using said input once said code or ID is correctly entered, or said security cover is removed.

21. A controller according to claim 17 wherein said valve is located on a single output water line of a shower, bath califont or hot water supply line.

22. A controller according to claim 17 wherein the valve is connected to a line with several outputs wherein at least one is a major flow output and said timer or processor monitors a predetermined discrimination period whereby flow for less than the predetermined discrimination period is ignored and the timer is not started.

23. A controller according to claim 17 wherein the controller further comprises a proportional valve configured to limit or vary the maximum flow through the heated water line.

24. A controller according to claim 17 wherein said valve is a normally open solenoid valve and fails open.

25. A controller according to claim 17 further comprising a temperature sensor and wherein the output of said sensor is provided to the timer and wherein the predetermined flow period does not begin unless the temperature is above a predetermined level.

26. (canceled)

27. (canceled)

28. (canceled)

29. A controller according to claim 19 wherein said indication comprises at least one pulse of the hot water flow to indicate end of shower time programmed.

30. (canceled)

31. (canceled)

32. A controller according to claim 17 wherein the controller is adapted to store information on water use.

33. A controller according to claim 32 wherein the controller is adapted to upload the water use information to a computer, wherein the computer can be used to monitor water use.

34. (canceled)

35. (canceled)
